(19) United States
(12) Patent Application Publication
(10) Pub. No.: US 2017/0328278 A1
(43) Pub. Date: Nov. 16, 2017

(54) GAS TURBINE ENGINE

(71) Applicant: ROLLS-ROYCE plc, London (GB)

(72) Inventors: Zahid M HUSSAIN, Derby (GB); Oliver TAYLOR-TIBBOTT, Lichfield (GB)

(73) Assignee: ROLLS-ROYCE plc, London (GB)

(21) Appl. No.: 15/493,407

(22) Filed: Apr. 21, 2017

(30) Foreign Application Priority Data
May 13, 2016 (GB) 1608413.9

(51) Int. Cl. F02C 6/08

(52) U.S. Cl. CPC F02C 6/08

(57) ABSTRACT

A gas turbine engine comprises a bleed duct for receiving bleed flow and a plurality of valve members pivotable relative to the bleed duct for variably controlling fluid flow along the bleed duct. The gas turbine engine also comprises an actuation mechanism for pivoting the valve members relative to the bleed duct, wherein the actuation mechanism is configured such that pivoting of the valve members is staggered.

### TECHNICAL FIELD

The present disclosure concerns a gas turbine engine, and/or a method of operating a gas turbine engine.

### BACKGROUND

Gas turbine engines are typically employed to power aircraft. Typically a gas turbine engine will comprise an axial fan driven by an engine core. The engine core is generally made up of one or more turbines which drive respective compressors via coaxial shafts. The fan is usually driven off an additional lower pressure turbine in the engine core.

The fan comprises an array of radially extending fan blades mounted on a rotor and air travelling through the fan will provide a large percentage of the overall thrust generated by the gas turbine engine. The remaining portion of air from the fan is ingested by the engine core and is further compressed, combusted, accelerated and exhausted through a nozzle. The engine core exhaust mixes with the remaining portion of relatively high-volume, low-velocity air bypassing the engine core.

It is known to extract air from the working gas path of a gas turbine engine, either to manage the engine airflow and operating conditions or to provide an air supply for the passenger cabin or for other purposes. Generally, this air is extracted through one or more bleed valves in an engine casing, which are actuated (for example, by a solenoid or hydraulic actuator) to either an open position in which air can flow through it or a closed position in which no air can flow through it.

Air may be bled from the compressor to manage the operating conditions of the engine and/or for auxiliary functions such as providing air to a cabin of an aircraft. A valve is usually provided to control the bleed from the compressor. Conventionally the valve is a binary valve, that is the valve is of the type where it is either open or closed.

However, it has been suggested that a butterfly valve could be used to control the bleed from the compressor. A butterfly valve has a valve member that is provided in a valve housing and is pivotable thereto so as to vary the flow of fluid through the butterfly valve between an open position and a closed position.

### SUMMARY OF DISCLOSURE

According to a first aspect there is provided a gas turbine engine comprising a bleed duct for receiving bleed flow (e.g. bleed flow from a compressor of the gas turbine engine). A plurality of valve members are pivotable relative to the bleed duct for variably controlling fluid flow along the bleed duct. An actuation mechanism is provided for pivoting the valve members relative to the bleed duct. The actuation mechanism is configured such that pivoting of the valve members is staggered.

It may be considered that the valve members are pivoted non-simultaneously. When the actuation mechanism moves the valve members a first valve member may be pivoted before a second valve member is pivoted. For example, when the actuation mechanism moves the valve members from defining a position where the bleed duct is closed to a position where the bleed duct is open, a first valve member of the plurality of valve members starts to open before a second valve member of the plurality of valve members. When the actuation mechanism moves the valve members from defining a position where the bleed duct is open to a position where the bleed duct is closed, the first (or second) valve member of the plurality of valve members starts to close before the second (or first) valve member of the plurality of valve members.

The valve members may be sequentially operated. For example, pivoting of one of the plurality of valve members commences before pivoting of another valve member commences.

The actuation mechanism may include one or more link members that link the plurality of valve members.

The link members may be arranged such that actuation of one valve member initiates actuation of other valve members, e.g. valve members connected directly or indirectly to said one valve member via the link members.

The link members may comprise pins and/or slots arranged such that a pin of one link member is received in a slot of an adjacent link member. The slots may be curved.

The slots of the link members may be defined such that that a pin received in the slot starts to move in the slot before rotation of a respective valve member.

Each valve member may have a link member connected to it, e.g. at a position substantially aligned with an axis of rotation of the valve member.

The valve member may be a disc, e.g. a circular disc.

The bleed duct may comprise a plurality of housings at an entrance thereof. Each housing may house one valve member of the plurality of valve members.

The housings may define a cylindrical fluid flow path. The housings may be positioned axially adjacent to each other.

The actuation mechanism may comprise a ram, e.g. a hydraulic, pneumatic, or electrical ram for moving the link members, e.g. the ram may be connected to one of the link members and actuate said one of the link members. Actuation of said one of the link members may actuate directly or indirectly the remaining link members.

In alternative examples, the actuation mechanism may comprise rack and pinion gears, or a geared arrangement.

The gas turbine engine may comprise a bypass duct and a compressor. The bleed duct may extend to bleed air from the compressor to the bypass duct.

A brush seal may define a seal between the valve member and a housing that defines a portion of the bleed duct.

A portion of the bleed duct may be defined by a plurality of valve housings. One valve member may be positioned in each housing and be pivotable relative thereto.

The brush seal may be provided on the edge of the valve member. Alternatively, the brush seal may be provided on the housing.

The brush seal may comprise a plurality of bristles extending radially outwardly relative to the valve member. The brush seal may comprise a plurality of bristles arranged helically around the valve member. The bristles may be arranged helically in a clockwise and/or an anticlockwise direction.

The surface of the valve member may be shaped (e.g. contoured or comprises profiling elements) to optimise the position of the centre of pressure acting on the butterfly valve member.

According to a second aspect there is provided a valve arrangement comprising a plurality of valve members pivotable relative to the bleed duct for variably controlling fluid flow along the bleed duct; and an actuation mechanism for pivoting the valve members relative to the bleed duct. The actuation mechanism is configured such that pivoting of the valve members is staggered.

The valve arrangement of the second aspect may have one or more of the optional features of the first aspect, where the optional features relate to features of a valve arrangement.

According to a third aspect there is provided a method of operating a gas turbine engine, the gas turbine engine comprising a bleed duct for receiving bleed flow (e.g. bleed flow from a compressor of the gas turbine engine), and a plurality of valve members pivotable relative to the bleed duct for variably controlling fluid flow along the bleed duct, the method comprising pivoting each valve member of the plurality of valve members in a staggered relationship to each other.

The gas turbine engine may be the gas turbine engine of the first aspect.

According to a fourth aspect there is provided a gas turbine engine comprising a bleed duct for receiving bleed flow (e.g. bleed flow from a compressor of the gas turbine engine); a valve member pivotable relative to the bleed duct for variably controlling fluid flow along the bleed duct; and a brush seal provided between the bleed duct and the valve member.

According to a fifth aspect there is provided a butterfly valve comprising a housing, a valve member pivotable relative to the housing, and a brush seal provided between the housing and the valve member.

According to a sixth aspect there is provided a gas turbine engine comprising a bleed duct for receiving bleed flow (e.g. bleed flow from a compressor of the gas turbine engine); a valve member pivotable relative to the bleed duct for variably controlling fluid flow along the bleed duct, wherein the valve member (e.g. one or more faces of the valve member) is profiled such that a centre of pressure on the valve member during operation of the valve is close to or coincident with an axis of rotation of the valve member.

The valve member may be contoured and/or elements may be attached to the valve member.

According to a seventh aspect there is provided a butterfly valve comprising a housing, a valve member pivotable relative to the housing, and a brush seal provided between the housing and the valve member.

The skilled person will appreciate that except where mutually exclusive, a feature described in relation to any one of the above aspects may be applied mutatis mutandis to any other aspect.

### DESCRIPTION OF THE DRAWINGS

Embodiments will now be described by way of example only, with reference to the Figures, in which:

FIG. 1 is a sectional side view of a gas turbine engine;

FIG. 2 is a sectional schematic of a bleed arrangement between a bypass duct and compressor of the engine of FIG. 1;

FIG. 3A is a schematic of a valve member of the bleed arrangement of FIG. 2 in a closed position;

FIG. 3B is a schematic of a valve member of the bleed arrangement of FIG. 2 in an open position;

FIG. 4 is a schematic sectional view of the bleed arrangement of FIG. 2 in a closed position and illustrating link members that connect the valve members of the bleed arrangement;

FIG. 5 is a schematic sectional view of the bleed arrangement of FIG. 2 in an open position and illustrating link members that connect the valve members of the bleed arrangement;

FIG. 6 shows a graph illustrating valve control accuracy A against percentage of valve opening (i.e. the valve in a closed position is indicated by 0 and the valve in the open position is indicated by 100) for a bleed arrangement having a single butterfly valve and for the bleed valve arrangement having multiple valve members (e.g. five valve members);

FIGS. 7A to 7D schematically illustrate alternative arrangements of valve and link members;

FIG. 8 illustrates a valve member;

FIG. 9 illustrates an alternative valve member; and

FIG. 10 illustrates bristles that may be provided around the edge of the valve member of FIG. 8 or FIG. 9.

### DETAILED DESCRIPTION

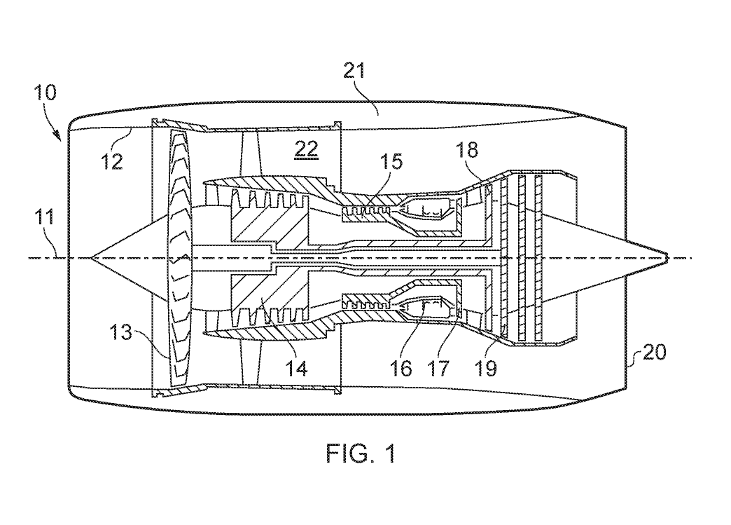

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

Referring now to FIG. 2, a bleed arrangement from the compressor, in this case the intermediate pressure compressor 14 is indicated generally at 24. The bleed arrangement includes a bleed duct 26 for receiving a bleed flow from the compressor. A flexible seal 28 is provided and circumferentially surrounds a portion of the bleed duct. The flexible seal is provided to prevent leakage of bypass air into a fire zone that is located around the bleed duct, and to prevent leakage of fire zone ventilation air into the bypass duct 22. A valve arrangement 30 is provided between an engine casing 29 proximal to the compressor and the bypass duct 22.

The cross sectional area of the bleed duct 26 is greater downstream of the valve arrangement 30 than upstream of the valve arrangement (upstream and downstream referring to the general direction of air flow through the bleed duct). The walls of the bleed duct are substantially parallel, but in alternative embodiments the walls may converge towards the bypass duct 22. In the present embodiment the bleed duct is open directly to the bypass duct 22; however in alternative embodiments a barrier may be provided between the bypass duct 22 and the bleed duct 26. The barrier may be a perforated sheet or a wire mesh. The perforations in the sheet or the holes formed in the mesh may be small enough to prevent debris such as bolts entering the bleed duct. In some embodiments the barrier may be a “pepper pot”. In such embodiments, the perforations or holes may be small enough to reduce noise (for example they may have a diameter of approximately 3 mm). In further alternative embodiments, the barrier may be a slotted barrier, for example a louvered barrier.

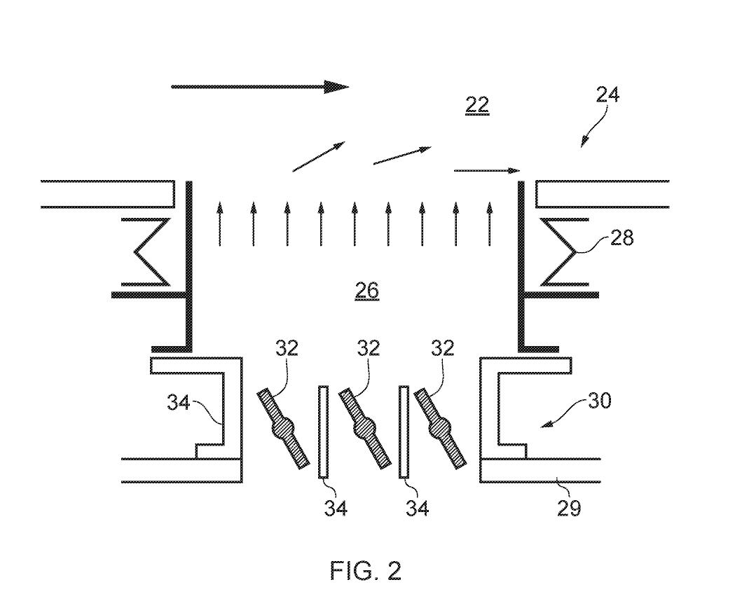

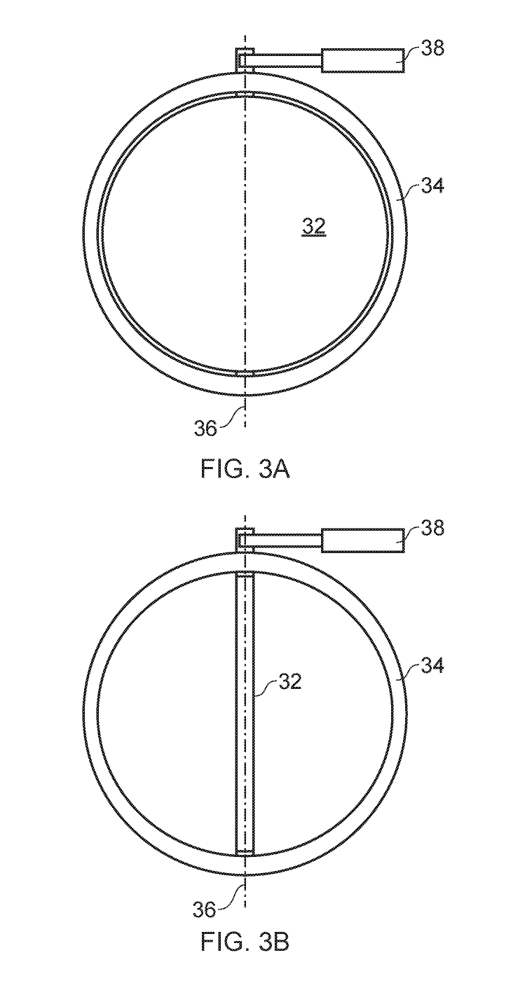

Referring to FIGS. 2, 3A and 3B, the valve arrangement 30 includes a plurality of butterfly valves (in this example three butterfly valves). Each valve includes a valve member 32 and a housing 34. The housing 34 defines a fluid flow path for fluid flow through the butterfly valves, and defines a portion of the bleed duct 26. In the present example each housing is cylindrical.

Each valve member 32 is disc shaped. In the present example the faces of each valve member are planar, but in alternative embodiments the faces of the valve member may have any suitable profile. For example, the face of the valve member may be profiled, e.g. be contoured or have elements attached to the face. The profiling of the valve member may be such that the centre of pressure of the butterfly valve is positioned closer to a physical axis of the valve (i.e. a rotational axis (discussed below) about which the valve member pivots) during the highest aerodynamically loaded conditions during operation of the gas turbine engine.

Each valve member 32 is pivotally connected to the respective housing 34. Each valve member is connected to the respective housing at two diametrically opposed positions. The valve member 32 is connected to the housing 34 such that the valve member is pivotable about a rotational axis 36. The rotational axis 36 extends between the two positions of connection with the housing.

An actuator 38 is provided. The actuator 38 is configured to move the valve members 32 directly or indirectly between an open and a closed position and variable positions there between. In the present example the actuator is a ram, e.g. a hydraulic or pneumatic ram

The closed position of the valve member 32 is illustrated in FIG. 3A. In the closed position the valve member substantially blocks the fluid flow path defined by the housing 34. It could be considered that in the closed position, when the butterfly valve is viewed from an axial end, the valve member is concentric the fluid flow path (or bore) of the housing. The open position of the valve member 32 is illustrated in FIG. 3B. In the open position the valve member is positioned so as to block the fluid flow path by a minimal amount. In the present example, the valve member 32 is positioned orthogonal to the closed position.

When the butterfly valve is viewed from an axial end, in the open position only a portion of the circumferential face of the valve member is visible.

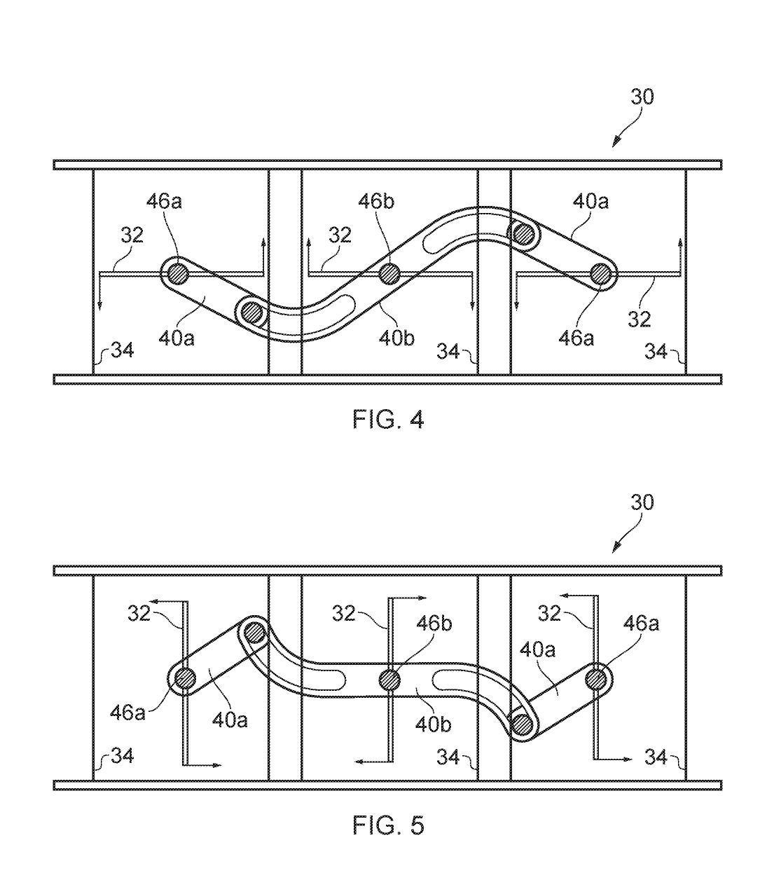

Referring now to FIGS. 4 and 5, the valve members of the valve arrangement 30 are connected by link members 40a, 40b. In the present example two types of link members are provided. The first type of link member 40a is a straight member having a pin 44 positioned at one end. An opposite end of the link member 40a is connected to the valve member 32 at a position 46a substantially aligned with the axis of rotation of the valve member. In the valve arrangement 30 shown in FIGS. 4 and 5, an array of three valves (i.e. three valve members and respective housings) are arranged axially adjacent each other. One of the first type of link members is connected to the end valve members of the array of three (i.e. to each valve member adjacent the central valve member of the array).

The second type of link member 40b is a curved link member. The curved link member includes a central portion that is straight and two end portions that are curved. The two end portions are curved in the same direction. A slot 42 is provided in each end portion. The slot 42 is curved. In the present example the slot 42 follows the curved profile of the end portions. The pins 44 of the first type of link member 40b are received in the slot 42 at the respective end of the second type of link member. The second type of link member is connected to the valve member at a position 46b substantially aligned with the axis of rotation of the valve member. In the present example, the second type of link member is connected to the central valve member of the array of three.

An axle or similar may be provided through the valve member and the link member may be connected to one end of said axle. The link member may be connected (e.g. rigidly connected to the axle or similar) to the valve member such that the link member rotates with the valve member or the valve member rotates with the link member. That is, relative movement between a link member and the respective connected valve member is limited.

During operation of the gas turbine engine, to open the valves fully or by a certain degree, the actuator rotates one of the valve members, for example a valve member at one end of the array, about the rotational axis of the valve member. As the valve member rotates, the respective link member rotates. Rotation of the link member causes the respective pin to move in the respective slot of the or an adjacent link member. Movement of the pin in the slot causes rotation of the adjacent link member, which actuates opening of the respective valve member by rotating the valve member about its rotational axis. In this way all linked link members actuate rotation of the valve members when one valve member is actuated. In the arrangements shown, the valve members are actuated sequentially, i.e. directly linked valve members commence opening one after another. Indeed, in the present example, a first valve is opened, then a second valve is opened and then a third valve is opened. That is the pin of the respective link member slides in the slot and when it comes to a stop actuation of the respective linked valve member is initiated.

To close the butterfly valves a similar process as to open the butterfly valves is followed, but the actuator rotates the butterfly valve in the reverse direction.

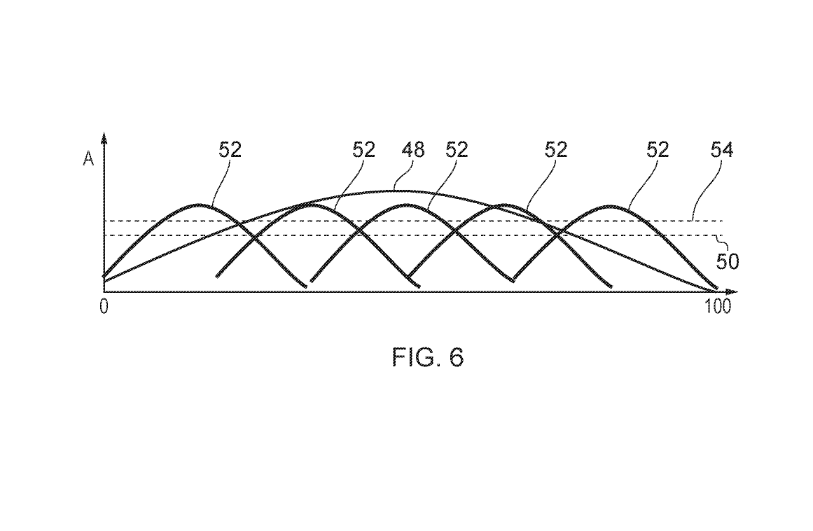

The described arrangement provides increased accuracy of control of the bleed flow through the bleed duct. Referring to FIG. 6, the accuracy of control (A) is indicated on the y-axis and the amount the duct is open is indicated on the X-axis. As can be seen from this graph, when a single butterfly valve is used (indicated by line 48) the accuracy of control when the valve is close to being fully open or fully closed is reduced compared to when the valve is fully open.

The mean accuracy of control is indicated by dotted line 50.

In the described example where multiple valves are used having staggered opening permits a wider range of accuracy of opening of the valves, as indicated by the accuracy of operation lines 52, and the mean accuracy of control indicated by dotted line 54. It can be seen from a comparison of the mean lines that the described example a wider range of control with increased accuracy can be achieved.

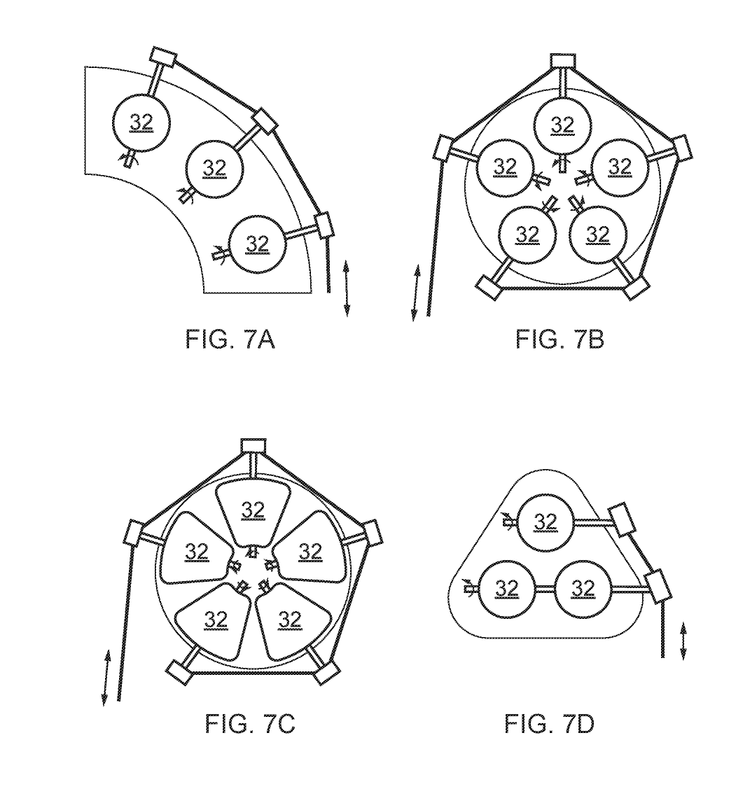

As will be appreciated by the person skilled in the art, the valve members and link members can be arranged in a variety of ways, for example depending on the space requirements or needs of the local environment. Various alternative example valve arrangements are illustrated in FIGS. 7A to 7D.

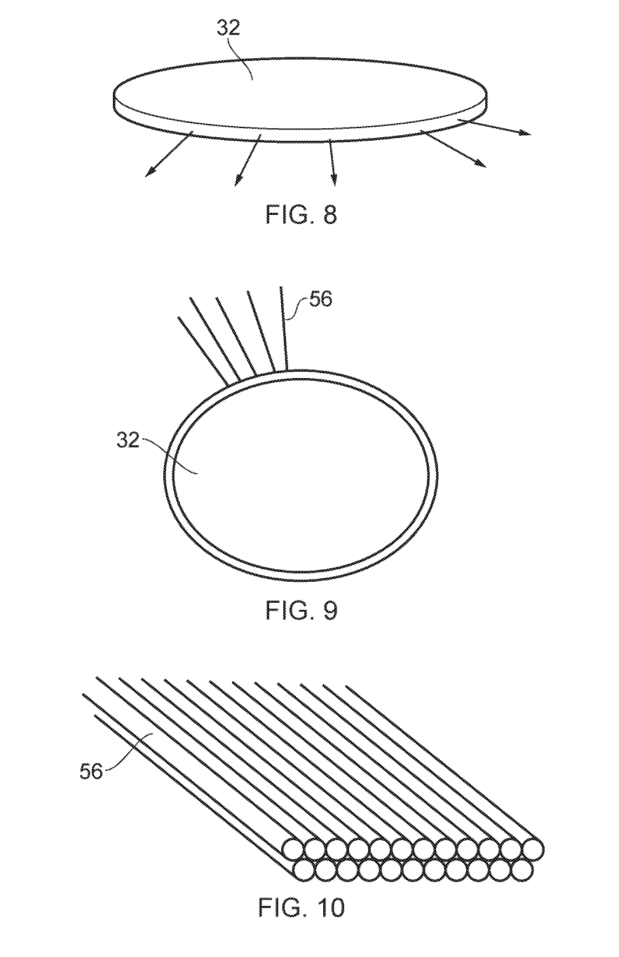

Referring now to FIGS. 8 to 10, the housing of the butterfly valve or the valve member 32 may include a brush seal. In the examples shown in FIGS. 8 and 9, the bush seal is connected to the valve member. Bristles 54 extend radially outwardly from the valve member 32. The bristles may extend directly radially outwardly, or they may extend radially outwardly and be angled towards one side of the valve member. In some examples, the bristles may be spirally arranged in either a clockwise or a counter clockwise direction. The bristles in the present example are overlapping. The bristles may extend radially from the valve member (or the housing) by a distance of approximately 0.5 mm.

The use of a brush seal reduces leakage between the valve member and the valve housing.

In the present example a single actuator is provided, but in alternative embodiments multiple actuators may be provided. In such examples, each actuator may be arranged to commence movement of the valve members at a different time to when movement of another valve member is commenced.

In the present example the valve members are connected by link members, but in alternative embodiments the valve members may be connected by an alternative arrangement, for example by rack and pinion gears, quarter gears intermeshing only at a time when staggered opening is required, or a worm gear. When gears are used, gear ratios can be selected to provide the desired control of rate of opening and closing of the butterfly valves. The gears may be provided with regions free of teeth. In this way, the gears can be arranged so that there is a delayed opening on one valve which when engaged has an accelerated opening via its gear ratio. The gears may by non-circular gears. For example, a smaller diameter gear and a larger diameter gear may be provided. The gears may have a region that is substantially defined by a circle. A portion of the gears adjacent said region may on the smaller gear include a concave surface and on the larger gear include a convex surface. The convex surface is configured to engage the concave surface.

The present example has been described in relation to valves arranged within the vicinity of the same bleed duct, but in alternative embodiments the valves may be mounted on different sides of the engine, for example a port side and a starboard side of the engine.

It will be understood that the invention is not limited to the embodiments above-described and various modifications and improvements can be made without departing from the described herein. Except where mutually exclusive, any of the features may be employed separately or in combination with any other features and the disclosure extends to and includes all combinations and sub-combinations of one or more features described herein.

1. A gas turbine engine comprising:
a bleed duct for receiving bleed flow;
a plurality of valve members pivotable relative to the bleed duct for variably controlling fluid flow along the bleed duct; and
an actuation mechanism for pivoting the valve members relative to the bleed duct, wherein the actuation mechanism is configured such that pivoting of the valve members is staggered.

2. The gas turbine engine according to claim 1, wherein the valve members are sequentially operated, such that pivoting of one of the plurality of valve members commences before pivoting of another valve member commences.

3. The gas turbine engine according to claim 1, wherein the actuation mechanism includes one or more link members that link the plurality of valve members.

4. The gas turbine engine according to claim 3, wherein the link members comprise pins and/or slots arranged such that a pin of one link member is received in a slot of an adjacent link member.

5. The gas turbine engine according to claim 4, wherein the slots are curved.

6. The gas turbine engine according to claim 1, comprising a bypass duct and a compressor, and wherein the bleed duct extends to bleed air from the compressor to the bypass duct.

7. The gas turbine engine according to claim 1, wherein a brush seal defines a seal between the valve member and a housing that defines a portion of the bleed duct.

8. The gas turbine engine according claim 1, wherein the surface of the valve member is shaped to optimise the position of the centre of pressure acting on the valve member.

9. A method of operating a gas turbine engine, the gas turbine engine comprising a bleed duct for receiving bleed flow, and a plurality of valve members pivotable relative to the bleed duct for variably controlling fluid flow along the bleed duct, the method comprising pivoting each valve member of the plurality of valve members in a staggered relationship to each other.

10. A valve arrangement comprising:
a plurality of valve housings arranged adjacent to each other;
a valve member provided in and pivotable relative to each of the valve housings for variably controlling fluid flow through the plurality of housings; and
an actuation mechanism for pivoting the valve members relative to the valve housings, wherein the actuation mechanism is configured such that pivoting of the valve members is staggered.

11. The valve arrangement according to claim 10, wherein the plurality of valve housings define a bleed duct inlet.

12. The valve arrangement according to claim 10, wherein the valve housings each define a cylindrical fluid flow path.
